(19) United States
(12) Patent Application Publication
(10) Pub. No.: US 2012/0219879 A1
(43) Pub. Date: Aug. 30, 2012

(54) PROTON EXCHANGE MEMBRANE COMPRISING POLYMER BLENDS FOR USE IN HIGH TEMPERATURE PROTON EXCHANGE MEMBRANE FUEL CELLS

(75) Inventors: Jin Hu, Antwerpen Berchem (BE); Olaf Conrad, Mowbray (ZA)

(73) Assignee: EWE-FORSCHUNGSZENTRUM FÜR ENERGIETECHNOLOGIE E.V., Oldenburg (DE)

(21) Appl. No.: 13/498,233

(22) PCT Filed: Sep. 24, 2009
(86) PCT No.: PCT/EP09/06904

§ 371 Date: May 18, 2012

(51) Int. Cl. H01M 8/10

(52) U.S. Cl. 429/494; 429/492

(57) ABSTRACT

Use of a proton exchange membrane M in proton exchange membrane fuel cells, wherein the membrane M comprises a blend of (I) at least one polybenzimidazole polymer PBI which comprises, in polymerized form, at least 90 mol-% monomeric units U of formula (I) and/or (II), based on the total amount of monomeric units of the polybenzimidazole polymer PBI, wherein Y is a substituted element selected from O and S; or Y is a single carbon-carbon bond; Z is selected from the group consisting of divalent C₁-C₁₀ alkanediyl; divalent C₂-C₁₀ alkenediyl; divalent C₆-C₁₅ aryl; divalent C₅-C₁₅ heteroaryl; divalent C₅-C₁₅ heterocyclyl; divalent C₆-C₁₉ aryl sulfone; and divalent C₆-C₁₉ aryl ether; and wherein the total amount of monomeric units U in the polybenzimidazole polymer PBI is from about 100 to about 10,000; and (III) at least one sulfonated polymer SP, which comprises, in polymerized form, at least 50 mol-% monomeric units U′, based on the total amount of monomeric units of the sulfonated polymer SP, wherein at least one of the monomeric units U′ carries at least one moiety —SO₃H; wherein the membrane M is essentially free of water and exhibits a proton conductivity at a temperature of 100° C. or more, preferably in the range of from 100 to 250° C. of at least 10⁻⁵ S/cm, as measured by impedance method.

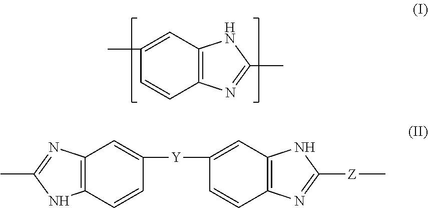

The present invention relates to proton exchange membranes for use in proton exchange membrane fuel cells, in particular in high temperature polymer electrolyte membrane fuel cells (PEMFC) and direct methanol fuel cells (DMFC), comprising polybenzimidazole polymers; and to methods for the production of such proton exchange membranes. The invention further relates to proton exchange membrane fuel cells, comprising such proton exchange membranes.

Fuel cells are efficient devices that generate electric power via chemical reaction of fuels (e.g. hydrogen or methanol) and oxygen-containing gas. Fuel cells may be classified according to the electrolyte used in the fuel cell. The types of fuel cells include polymer electrolyte membrane fuel cells (PEMFC, including direct methanol fuel cells (DMFC)), phosphoric acid fuel cells (PAFC), molten carbonate fuel cells (MCFC), and solid oxide fuel cells (SOFC). The working temperatures of the fuel cells and their constitute materials vary depending on the type of electrolyte used in a cell.

The basic PEMFC and DMFC include an anode (fuel electrode), a cathode (oxidizing agent electrode), and a polymer electrolyte membrane (hereinafter also referred to as proton exchange membrane) intermediated between the anode and the cathode. The anode includes a catalyst layer to promote the oxidation of a fuel, and the cathode includes a catalyst layer to promote the reduction of an oxidizing agent. Examples of fuel that may be supplied to the anode include hydrogen, a hydrogen-containing gas, a mixture of methanol vapor and water vapor, and an aqueous methanol solution. Examples of the oxidizing agent supplied to the cathode include oxygen, oxygen containing gas, and air.

The polymer electrolyte membrane acts as an ionic conductor for the migration of protons from the anode to the cathode and also acts as a separator for preventing contact between the anode and the cathode. Therefore, the polymer electrolyte membrane proper-ties should include sufficient ionic conductivity, electrochemical safety properties, high mechanical strength, thermal stability at the operating temperature of the fuel cell, and should be easily formed into a thin layer.

The up-to-date PEMFC and DMFC technology is based on sulfonated polymer membranes (e.g., Nafion®) as the electrolyte. Sulfonated polymers exhibit generally good chemical stability and proton conductivity at high relative humidity and low temperature. However, the presence of liquid water limits the operational temperature of PEMFC and DMFC to below 100° C. under atmospheric pressure, typically around 80° C., since the proton is conducted by the assistant of liquid water (proton solvent) in the sulfonated polymer membranes. Furthermore, for both PEMFC and DMFC, they have the disadvantage of the cost of materials (namely the noble metal catalysts and the perfluorosulfonic membrane), and the cost of the affiliated system which are presently higher with respect to conventional energy conversion systems. In addition, DMFC presently suffer from methanol crossover across polymer electrolyte membranes and poor methanol electro-oxidation kinetics at low temperature on Pt-based anode catalysts.

It is expected that most of the shortcomings associated with the low-temperature PEMFC and DMFC technology could be partly solved or avoided by operating at high temperatures, i.e. in particular above 100° C. Potential advantages include the following: (1) enhanced kinetics for both electrode reactions, which is of special importance for the direct oxidation of methanol in DMFC; (2) enhanced CO tolerance, making it possible for a PEMFC to use hydrogen directly from a simple reformer, so that the affiliate component can be eliminated from the fuel processing system; (3) simple cooling and water management system, due to the high operation temperature (above the water boiling point) and the increased temperature gradient between the fuel cell stack and the coolant; thereby significantly improving the overall system efficiency. Moreover, high reliability, less maintenance, and better transient response capacities can also be expected as the potential advantages of the high-temperature PEMFC technology.

Various methods have been proposed to raise the operating temperature of a PEMFC to 100° C. or higher, including a method providing a PEMFC with a humidification apparatus, and a method operating under pressurized conditions. When a PEMFC is operated under pressurized conditions, the boiling point of water increases, such that the operating temperature can be rasied. But the use of a pressurizing system or a humidification apparatus increases the size and weight of the PEMFC, and reduces the efficiency of the power generating system.

Consequently, the availability of proton conducting membranes retaining satisfactory conductivity at high temperature (typically 100-200° C.) without humidification could permit the realization of PEMFC and DMFC which are of special interest for the co-generation stationary power plant application and electric vehicle.

The poor proton conductivity of sulfonated polymer membranes at high temperature (typically 100° C. or more, e.g. 100-200° C.) is mainly due to the loss of water (which acts as proton solvent). Therefore, a feasible approach to sulfonated polymer membranes (which act as a proton donor) suitable for high temperature PEMFC and DMFC operation could be e.g. providing sulfonated polymer membranes with insoluble and nonvolatile material, which can act as proton solvents (proton acceptor) similar to water. The most effective proton solvent besides water is imidazole (Im), containing both proton donor group (NH) and acceptor group (N). The mechanism for the proton transport of Im is shown below:

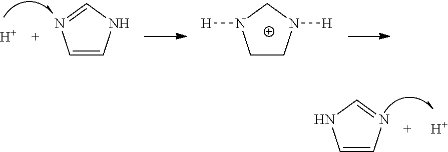

However, besides the relative high volatility and low thermal-oxidative stability at elevated temperature, another drawback for these low molecular weight Im-compounds (e.g. imidazole, alkyl imidazole, benzimidazole, benzimidazole sulfonic acid) is that they are highly water and methanol soluble. Consequently, they will be leached out from the membrane and poison the catalyst, which makes them impossible for practical fuel cells application be it at low or high operation temperature.

The newest technology in this field, providing essentially insoluble, thermal-oxidatively stable and non-volatile Im-containing polymers to be used as a membrane material, is based on polybenzimidazole (PBI, Celazole™ from Hoechst Celanese), the chemical structure of which is shown below:

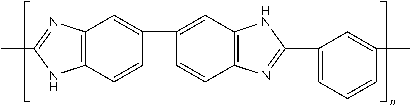

PBI is a water-insoluble polymer, and it contains the Im cycles in the polymer chain. The excellent chemical and thermal stability of PBI allows for facilitated application in high temperature fuel cells. For an overview on PBI and related polymers, see e.g. Deborah J. Jones and Jacques Roziére, J. Membrane Science, Vol. 185, Issue 1, 2001, pages 41-58.

Another approach of introducing PBI into sulfonated functionality membranes has been proposed by R. Wycisk et al., J. of Power Sources, Vol. 163, No. 1, 2005, p. 9-17. In this reference, sulfonated polymer (Nafion®) has been blended with PBI polymers at PBI levels of up to 8 wt.-%. This approach was primarily directed to reduce membrane water swelling. Thus, PBI is used as a filler to decrease methanol permeability of the Nafion® membrane. Proton conductivity measurements have been carried out at room temperature under fully humidified state.

Accordingly, it is an object of the present invention to provide a PBI-based membrane with good proton conductivity at high temperature of 100° C. and above, which at least partially overcomes the drawbacks of the prior art. Such polymer electrolyte membrane/proton exchange membrane should be easily formed into a thin layer for use in proton exchange membrane fuel cells, in particular in high temperature polymer electrolyte membrane fuel cells (PEMFC) and direct methanol fuel cells (DMFC). Additionally, membrane properties should include high mechanical strength and/or thermal stability at the operating temperature of the fuel cell. Another aspect is that sufficient electrochemical safety properties are required.

The above object(s) is (are) solved by a proton exchange membrane, comprising a blend of at least one polybenzimidazole polymer PBI and a sulfonated polymer SP, and option-ally an electron-deficient compound (anion receptor) BC, for use in proton exchange membrane fuel cells which may be operated at high temperature of 100° C. or more, and at low or very low water content, or even in a state where the membrane is essentially free of water.

The invention is described more fully hereinafter with reference to general and specific embodiments. This invention may, however, be embodied in many different forms and should not be construed as limited to the embodiments set forth herein. Rather, these embodiments are provided so that this disclosure is thorough, and will fully convey the scope of the invention to those skilled in the art. Additional features of the invention will be set forth in the description which follows, and in part will be apparent from the description, or may be learned by practice of the invention. It is to be understood that both the foregoing general description and the following detailed description are exemplary and explanatory and are intended to provide further explanation of the invention as claimed.

In a first aspect, therefore, the present invention relates to the use of a proton exchange membrane M in proton exchange membrane fuel cells, wherein the membrane M comprises a blend of
(I) at least one polybenzimidazole polymer PBI which comprises, in polymerized form, at least 90 mol-%, preferably at least 95 mol-%, and particularly preferred at least 99 mol-% monomeric units U of formula (I) and/or (II), based on the total amount of monomeric units of the polybenzimidazole polymer PBI,

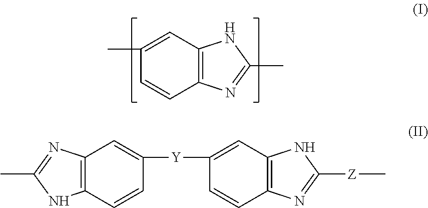

wherein
Y is a substituted element selected from O and S; or Y is a single carbon-carbon bond; preferably Y is O or a single carbon-carbon bond;
Z is selected from the group consisting of divalent C₁-C₁₀ alkanediyl, preferably C₁-C₆ alkanediyl, and more preferably C₁-C₄ alkanediyl; divalent C₂-C₁₀ alkenediyl; preferably C₂-C₆ alkenediyl, and more preferably C₂-C₄ alkenediyl; divalent C₅-C₁₅ aryl, preferably C₅-C₁₂ aryl; divalent C₅-C₁₅ heteroaryl, preferably C₅-C₁₂ heteroaryl; divalent C₆-C₁₅ heterocyclyl; preferably divalent C₅-C₁₂ heterocyclyl; divalent C₆-C₁₉ aryl sulfone, preferably C₆-C₁₂ aryl sulfone; and divalent C₆-C₁₉ aryl ether, preferably C₆-C₁₂ aryl ether; and
   wherein the total amount of monomeric units U in the polybenzimidazole polymer PBI is from about 100 to about 10,000; and
(II) at least one sulfonated polymer SP, which comprises, in polymerized form, at least 50 mol-%, preferably at least 75 mol-%, particularly preferred at least 90 mol-%, and more particularly preferred at least 99 mol-% monomeric units U′, based on the total amount of monomeric units of the sulfonated polymer SP, wherein at least one of the monomeric units U′ carries at least one moiety —SO₃H;
   wherein the membrane M is essentially free of water and exhibits a proton conductivity at a temperature of 100° C. or more, preferably in the range of from 100 to 250° C., and more preferably in the range of from 100 to 200° C., of at least 10⁻⁵ S/cm, preferably at least 2×10⁻⁵ S/cm, and most preferably at least 5×10⁻⁵ S/cm, as measured by impedance method, in particular as described by K. Uosaki et al., J. Electroanal. Chem., Vol. 287 (1990), 163-167.

Since the membrane M according to the invention is adapted for operating at high temperatures, i.e. above 100° C., most of the shortcomings associated with the low-temperature PEMFC and DMFC technology can be partly solved or avoided. The ensuing advantages include: (1) The kinetics for both electrode reactions are enhanced, which is of special importance for the direct oxidation of methanol in DMFC. (2) The CO tolerance is dramatically enhanced, from 10-20 ppm of CO at 80° C., to 1.000 ppm at 130° C., and up to 30.000 ppm at 200° C. This high CO tolerance makes it possible for a PEMFC to use hydrogen directly from a simple reformer, so that the affiliate component can be eliminated from the fuel processing system. (3) The required cooling system is simple and practically possible due to the increased temperature gradient between the fuel cell stack and the coolant. Furthermore, the water management system is not necessary since the operation temperature is above the water boiling point. In this way the overall system efficiency is significantly improved. High reliability, less maintenance, and better transient response capacities are further advantages of the high-temperature PEMFC technology.

Without any intent to be bound by theory, it is believed that the good proton conductivity of the membrane M according to the invention at high temperature (at or above 100° C.) can be attributed to a specific interaction between the polybenzimidazole polymer PBI and the sulfonated polymer SP employed in the membrane M. Namely, it is believed that this kind of polymer blend membrane can conduct protons without water, since it has both a proton donor group (sulfonic acid group) and a proton acceptor group (Im cycle). Furthermore, proton conductivity can be significantly enhanced by addition of an electron-deficient compound, in particular an electron-deficient boron compound BC, to such a blend material. In principle, this kind of PBI-SP membrane or PBI-SP-BC membrane, respectively, should work as the membrane for the PEMFC and DMFC operated at high temperature without the existence of water, since the authors of the present invention propose membranes M according to the invention which exhibit good proton conductivity at high temperatures (at or above 100° C.) under conditions where the membrane M is essentially free of water.

The possible proton conduct mechanism based on the aforementioned principle (which may be referred to as “proton donor-proton acceptor” concept) is shown in the FIGURE below, using the Nafion® membrane as an example of a sulfonated polymer.

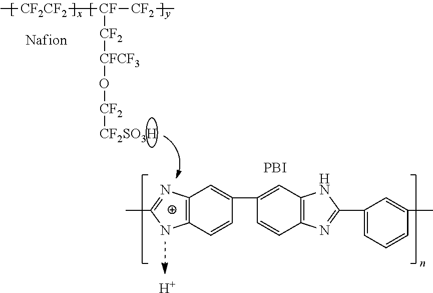

If PBI acts as a proton solvent in a blend membrane under anhydrous conditions, carrier mobility should be further enhanced by providing for an effective separation of charges, in analogy to the hydration sphere in hydrated Nafion. Then, as a consequence, more “free” protons would be conducted through the benzimidazole ring. Since the —SO₃— group is an electron-rich group and can act as a Lewis base, it is feasible that the overall proton conductivity of the above blend membranes can be improved by the strategy of creating composite membrane materials using electron-deficient compounds (i.e. anion receptors) that can act as Lewis acids.

After incorporation of Boron-based electron-deficient compounds, the possible proton conduct mechanism is shown in the FIGURE below, using the Nafion® membrane as an example of a sulfonated polymer and (C₆F₅)₃B (tri(perfluoro phenylene) boron, TPFPB) as an example of a Boron-based electron-deficient compound.

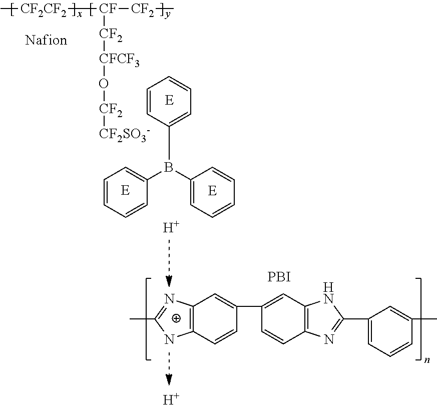

The definitions of the variables used in the preceding formulae, and used in the formulae hereinafter in general, include generic terms which represent the respective substituents.

In the term Cₙ-Cₘ, n and m, respectively, indicate the possible number of carbon atoms in each of the substituents or in a specific moiety of such substituent.

The term “divalent” indicates that the respective group or moiety, e.g. divalent alkanediyl and divalent arylalkyl, has two valencies available for binding said group or moiety to two distinct (i.e. different) molecular sites. As an example, in the moiety —Z— of formula (I) above, —Z— may be e.g. divalent alkanediyl, i.e. an alkyl group which is covalently bonded to two distinct molecular sites via two carbon-carbon single bonds. In this case, the “two distinct molecular sites” are (1) the carbon atom in between the two nitrogen atoms of a benzimidazole ring system of a first monomeric unit of formula (I), and (2) the carbon atom in between the two nitrogen atoms of a benzimidazole ring system of a second monomeric unit of formula (I) which is adjacent to said first monomeric unit. It is to be noted that herein the terms “alkanediyl”, “divalent alkanediyl”, and “divalent alkyl” are used synonymously, in each case having the meaning of “divalent” as defined herein. The same applies to other groups and/or moieties which are defined as being “divalent”, including (di-valent) haloalkanediyl, (divalent) alkenediyl, divalent aryl (also referred to as arylenediyl), divalent arylalkyl, divalent heteroaryl (also referred to as heteroarylenediyl), divalent aryl sulfone (also referred to as arylenediyl sulfone); and divalent aryl ether.

Halogen: fluorine, chlorine, bromide and iodide; in particular fluorine, chlorine, and bromide; and especially fluorine.

Alkyl, and the alkyl groups in alkylaryl and alkylsultone: saturated, linear or branched hydrocarbon groups having 1 to 10, e.g. 2, 4, 6 or 8 hydrocarbon atoms, e.g. C₁-C₁₀ alkyl, such as methyl, ethyl, n-propyl, 1-methyl ethyl, n-butyl, 1-methyl propyl, 2-methyl propyl, 1,1-dimethyl ethyl, n-pentyl, 1-methyl butyl, 2-methyl butyl, 3-methyl butyl, 2,2-dimethyl propyl, 1-ethyl propyl, n-hexyl, 1,1-dimethyl propyl, 1,2-dimethyl propyl, 1-methyl pentyl, 2-methyl pentyl, 3-methyl pentyl, 4-methyl pentyl, 1,1-dimethyl butyl, 1,2-dimethyl butyl, 1,3-dimethyl butyl, 2,2-dimethyl butyl, 2,3-dimethyl butyl, 3,3-dimethyl butyl, 1-ethyl butyl, 2-ethyl butyl, 1,1,2-trimethyl propyl, 1,2,2-trimethyl propyl, 1-ethyl-1-methyl propyl, 1-ethyl-2-methyl propyl, n-heptyl, 2-methyl hexyl, 3-methyl hexyl, n-octyl, 2-methyl heptyl, 3-methyl heptyl, n-nonyl, n-decyl, and the like.

Halogen alkyl (hereinafter referred to as haloalkyl): saturated, linear or branched hydro-carbon groups having 1 to 10, e.g. 2, 4, 6 or 8 hydrocarbon atoms, in particular the alkyl groups as defined above, wherein the hydrogen atoms of said groups may be fully or partially substituted by halogen atoms as defined above: e.g. C₁-C₁₀ haloalkyl, in particular C₁-C₁₀ fluoroalkyl, such as chloromethyl, bromomethyl, dichloromethyl, trichloromethyl, fluoromethyl, difluoromethyl, trifluoromethyl, chlorofluoromethyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 1,1,1-trifluoroprop-2-yl, and the like.

Alkanediyl: saturated, linear or branched hydrocarbon groups having 1 to 10, e.g. 2, 4, 6 or 8 hydrocarbon atoms, such as the alkyl groups defined above, wherein the (divalent) alkanediyl group has two valencies available for covalently binding said group or moiety to two distinct (i.e. different) molecular sites via two carbon-carbon single bonds; e.g. C₁-C₁₀ alkanediyl, such as methanediyl, ethanediyl, n-propanediyl, 1-methyl ethanediyl, n-butanediyl, 1-methyl propanediyl, 2-methyl propanediyl, 1,1-dimethyl ethanediyl, n-pentanediyl, 1-methyl butanediyl, 2-methyl butanediyl, 3-methyl butanediyl, 2,2-dimethyl propanediyl, 1-ethyl propanediyl, n-hexanediyl, 1,1-dimethyl propanediyl, 1,2-dimethyl propanediyl, 1-methyl pentanediyl, 2-methyl pentanediyl, 3-methyl pentanediyl, 4-methyl pentanediyl, 1,1-dimethyl butanediyl, 1,2-dimethyl butanediyl, 1,3-dimethyl butanediyl, 2,2-dimethyl butanediyl, 2,3-dimethyl butanediyl, 3,3-dimethyl butanediyl, 1-ethyl butanediyl, 2-ethyl butanediyl, 1,1,2-trimethyl propanediyl, 1,2,2-trimethyl propanediyl, 1-ethyl-1-methyl propanediyl, 1-ethyl-2-methyl propanediyl, n-heptanediyl, 2-methyl hexanediyl, 3-methyl hexanediyl, n-octanediyl, 2-methyl heptanediyl, 3-methyl heptanediyl, n-nonanediyl, n-decanediyl, and the like.

Halogen alkanediyl (hereinafter referred to as haloalkanediyl): saturated, linear or branched hydrocarbon groups having 1 to 10, e.g. 2, 4, 6 or 8 hydrocarbon atoms, wherein the alkanediyl group has two valencies available for covalently binding said group or moiety to two distinct (i.e. different) molecular sites via two carbon-carbon single bonds, in particular the alkanediyl groups as defined above, wherein the hydrogen atoms of said groups may be fully or partially substituted by halogen atoms as defined above: e.g. C₁-C₁₀ haloalkyl, in particular C₁-C₁₀ fluoroalkyl, such as chloromethyl, bromomethyl, di-chloromethyl, trichloromethyl, fluoromethyl, difluoromethyl, trifluoromethyl, chlorofluoro-methyl, dichlorofluoromethyl, chlorodifluoromethyl, 1-chloroethyl, 1-bromoethyl, 1-fluoroethyl, 2-fluoroethyl, 2,2-difluoroethyl, 2,2,2-trifluoroethyl, 2-chloro-2-fluoroethyl, 2-chloro-2,2-difluoroethyl, 2,2-dichloro-2-fluoroethyl, 2,2,2-trichloroethyl, pentafluoroethyl, 1,1,1-trifluoroprop-2-yl, and the like.

Alkenediyl: monoethylenically unsaturated, linear or branched hydrocarbon groups having 2 to 10, e.g. 2 to 4, 2 to 6, or 2 to 8, carbon atoms and a carbon-carbon double bond in any position of the chain of carbon atoms, e.g. C₂-C₁₀ alkenediyl, such as ethenediyl, propenediyl, 1-methyl ethenediyl, 1-butenediyl, 2-butenediyl, 1-pentenediyl, 2-pentenediyl, 3-pentenediyl, 1-hexenediyl, 2-hexenediyl, 3-hexenediyl, 1-heptenediyl, 2-heptenediyl, 3-heptenediyl, 1-octenediyl, 2-octenediyl, 3-octenediyl, 4-octenediyl, and the like.

Aryl: aromatic hydrocarbon having 6 to 15 ring member carbon atoms, in particular 6 to 12 ring member carbon atoms: homo-, bi- or tricyclic, in particular homo- or bicyclic hydro-carbon radicals, said aromatic cyclic groups in particular include phenyl and biphenyl.

Arylalkyl: aryl group as defined above, having 7 to 15 carbon atoms, 6 to 12 of which are ring member carbon atoms, wherein the aromatic cycle is substituted with one or more, e.g. 1, 2 or 3, in particular 1 alkyl group as defined above, such as C₁-C₆ alkyl, in particular linear C₁-C₆ alkyl, e.g. methylphenyl, ethylphenyl, propylphenyl, and butylphenyl.

Heterocycle: having 5 to 15 ring member atoms, in particular 5- or 6-membered heterocycle: homo-, bi- or tricyclic, in particular homo- or bicyclic hydrocarbon radicals containing 1, 2, 3 or 4 heteroatoms selected from the group consisting of a nitrogen atom, an oxygen atom and a sulfur atom; unsaturated (heterocyclyl) includes partially unsaturated, e.g. mono-unsaturated, and aromatic (heteroaryl); said heterocycles in particular include:
5-membered heteroaryl, containing 1, 2, 3 or 4 nitrogen atoms or 1, 2 or 3 nitrogen atoms and one sulfur or oxygen atom: 5-membered heteroaryl groups which, in addition to carbon atoms, may contain 1, 2, 3 or 4 nitrogen atoms or 1, 2 or 3 nitrogen atoms and one sulfur or oxygen atom as ring members, for example 2-furyl, 3-furyl, 2-thienyl, 3-thienyl, 2-pyrrolyl, 3-pyrrolyl, 3-isoxazolyl, 4-isoxazolyl, 5-isoxazolyl, 3-isothiazolyl, 4-isothiazolyl, 5-isothiazolyl, 3-pyrazolyl, 4-pyrazolyl, 5-pyrazolyl, 2-oxazolyl, 4-oxazolyl, 5-oxazolyl, 2-thiazolyl, 4-thiazolyl, 5-thiazolyl, 2-imidazolyl, 4-imidazolyl, 1,2,4-oxadiazol-3-yl, 1,2,4-oxadiazol-5-yl, 1,2,4-thiadiazol-3-yl, 1,2,4-thiadiazol-5-yl, 1,2,3-triazol-yl, 1,2,4-triazol-3-yl, tetrazolyl, 1,3,4-oxadiazol-2-yl, 1,3,4-thiadiazol-2-yl and 1,3,4-triazol-2-yl;
6-membered heteroaryl, containing 1, 2, 3 or 4 nitrogen atoms: 6-membered heteroaryl groups which, in addition to carbon atoms, may contain 1, 2, 3 or 4 or 1, 2 or 3 nitrogen atoms as ring members, for example 2-pyridinyl, 3-pyridinyl, 4-pyridinyl, 3-pyridazinyl, 4-pyridazinyl, 2-pyrimidinyl, 4-pyrimidinyl, 5-pyrimidinyl, 2-pyrazinyl, 1,2,3-triazinyl, 1,3,5-triazin-2-yl and 1,2,4-triazin-3-yl;
5- and 6-membered heterocyclyl, containing 1, 2, 3 or 4 nitrogen atoms or 1, 2 or 3 nitro-gen atoms and one sulfur or oxygen atom: 3-pyrazolidinyl, 4-pyrazolidinyl, 5-pyrazolidinyl, 2-pyrrolidin-2-yl, 2-pyrrolidin-3-yl, 3-pyrrolidin-2-yl, 3-pyrrolidin-3-yl, 1-piperidinyl, 2-piperidinyl, 3-piperidinyl, 4-piperidinyl, pyridin(1,2-dihydro)-2-on-1-yl, 2-piperazinyl, 1-pyrimidinyl, 2-pyrimidinyl, morpholin-4-yl and thiomorpholin-4-yl.

Aryl sulfone: aryl group (or arylalkyl group) as defined herein above, having 6 to 19 carbon atoms, in particular 6 to 12 carbon atoms, and carrying at least one, e.g. 1 or 2, in particular 1 sulfone moiety —SO₂, e.g. phenyl sulfone.

Aryl ether: aryl group (or arylalkyl group) as defined herein above, having 6 to 19 carbon atoms, in particular 6 to 12 carbon atoms, and comprising at least one, e.g. 1 or 2, in particular 1 ether moiety —O—, e.g. diphenyl ether.

Generally, the polybenzimidazole polymer PBI may comprise, in polymerized form, in the range of from 0 to about 100 mol-%, particularly in the range of from 5 to 95 mol-%, more particularly in the range of from 10 to 90 mol-%, and most particularly in the range of from 20 to 80 mol-% monomeric units U of formula (I), based on the total amount of monomeric units in the polybenzimidazole polymer PBI, except for any end groups terminating the polymer chains, such as low alkyl groups, e.g. methyl, ethyl or propyl. Herein, the monomeric units U of formula (I) may be linked to one another by a moiety Y or Z, in particular by a moiety Y, as defined above.

Generally, the polybenzimidazole polymer PBI may comprise, in polymerized form, in the range of from 0 to about 100 mol-%, particularly in the range of from 5 to 95 mol-%, more particularly in the range of from 10 to 90 mol-%, and most particularly in the range of from 20 to 80 mol-% monomeric units U of formula (II), based on the total amount of mono-meric units in the polybenzimidazole polymer PBI, except for any end groups terminating the polymer chains, such as low alkyl groups, e.g. methyl, ethyl or propyl. Herein, the monomeric units U of formula (II) may be linked to one another by a moiety Y or Z, in particular by a moiety Y, as defined above.

In one embodiment, the polybenzimidazole polymer PBI comprises, in polymerized form, at least 90 mol-%, preferably at least 95 mol-%, more preferably at least 99 mol-%, and particularly preferred at least 99.9 mol-% monomeric units U of formula (I), based on the total amount of monomeric units in the polybenzimidazole polymer PBI. In this case, the polybenzimidazole polymer PBI essentially consists of the monomeric units U of formula (I), apart from any end groups terminating the polymer chains, such as low alkyl groups, e.g. methyl, ethyl or propyl. In this embodiment, the monomeric units U of formula (I) may be linked to one another by a moiety Y or Z, in particular by a moiety Y, as defined above.

In another embodiment, the polybenzimidazole polymer PBI comprises, in polymerized form, at least 90 mol-%, preferably at least 95 mol-%, more preferably at least 99 mol-%, and particularly preferred at least 99.9 mol-% monomeric units U of formula (II), based on the total amount of monomeric units in the polybenzimidazole polymer PBI. In this case, the polybenzimidazole polymer PBI essentially consists of the monomeric units U of formula (II), apart from any end groups terminating the polymer chains, such as low alkyl groups, e.g. methyl, ethyl or propyl.

In another preferred embodiment, Z is selected from the group consisting of divalent C₄-C₈ alkanediyl, such as butanediyl, pentanediyl, hexanediyl, heptanediyl and octanediyl, more preferably linear C₄-C₈ alkanediyl; divalent C₂-C₈ alkenediyl, more preferably C₂-C₄ alkenediyl, in particular ethenyl and propenyl; divalent C₆-C₁₂ aryl, in particular phenyl group and diphenyl group; divalent C₅-C₁₂ heteroaryl, more preferably C₅-C₆ heteroaryl, in particular imidazole group and pyridine group; divalent C₅-C₁₂ heterocyclyl, more preferably C₅-C₆ heterocyclyl, in particular piperidine group; divalent C₆-C₁₅ aryl sulfone, more preferably C₆-C₁₂ aryl sulfone, in particular phenyl sulfone and diphenyl sulfone; divalent C₆-C₁₅ aryl ether, more preferably C₆-C₁₂ aryl ether, in particular phenyl ether and diphenyl ether.

In a particularly preferred embodiment of the present invention, Z is selected from the group consisting of phenylene, pyridylene, furylene, naphthalene, biphenylene, amylene and octamethylene.

In a very particularly preferred embodiment of the present invention, the polybenzimidazole polymer PBI is selected from poly-2,2′-(m-phenylene)-5,5′-bibenzimidazole; poly-2,2′-(pyridylene-3″,5″)-bibenzimidazole; poly-2,2′-(furylene-2″,5″)-5,5′-bibenzimidazole; poly-2,2′-(naphthalene-1″,6″)-5,5′-bibenzimidazole; poly-2,2′-(biphenylene-4″,4″)-5,5′-bibenzimidazole; poly-2,2′-amylene-5,5′-bibenzimidazole; poly-2,2′-octamethylene-5,5′-bibenzimidazole; poly-2,6′-(m-phenylene)-diimidazobenzene; poly-(1-(4,4-diphenylether)-5-oxybenzimidazole)-benzimidazole; poly-(1-(2-pyridine)-5-oxybenzimidazole)-benzimidazole; poly-(3-(4-(6-(1-benzimidazol-5-yloxy)-1-benzimidazol-2-yl)phenyl)-3-phenylisobenzofuran-1(3H)-one) and polybenzimidazole.

Preferably, the sulfonated polymer SP comprises, in polymerized form, at least 99.9 mol-% monomeric units U′, based on the total amount of monomeric units of the sulfonated polymer SP. In this case, the sulfonated polymer SP essentially consists of the monomeric units U′, apart from any end groups terminating the polymer chains, such as low alkyl groups, e.g. methyl, ethyl or propyl.

In another preferred embodiment, the monomeric units U′ of the sulfonated polymer SP comprise at least one, preferably 1 to 30, more preferably 1 to 5, divalent moiety(moieties) selected from the group consisting of:
(A) divalent C₁-C₁₀ alkanediyl, preferably C₁-C₆ alkanediyl, and more preferably C₁-C₄ alkanediyl; divalent C₂-C₁₀ alkenediyl, preferably C₂-C₆ alkenediyl, and more preferably C₂-C₄ alkenediyl;
(B) divalent C₆-C₁₅ aryl, preferably C₆-C₁₂ aryl, and more preferably C₆-C₁₀ aryl; and
(C) divalent C₃-C₁₀ cycloalkanediyl, preferably C₃-C₆ cycloalkanediyl; divalent C₄-C₁₀ cycloalkenediyl, preferably C₄-C₆ cycloalkenediyl;
   wherein any alkyl or alkenyl groups of the divalent moieties A, B and C, which have more than 2 carbon atoms, may comprise a heteroatom, selected from O and S, or a group —NR¹—, where R¹ is hydrogen or C₆-C₁₁ alkyl, within the alkyl or alkenyl chain of carbon atoms;
   wherein any cycloalkyl, cycloalkenyl or aryl groups of the divalent moieties A, B and C may comprise 1, 2, 3 or 4; preferably 1, 2 or 3; and more preferably 1 or 2 heteroatom(s) selected, independently from one another, from O, S and N, preferably N, as ring member atoms;
   wherein any of the aforementioned aliphatic, alicyclic, heterocyclic and aromatic groups of the definitions of the divalent moieties A, B and C may partially or completely be halogenated by fluorine and/or may carry 1, 2, 3 or 4; preferably 1, 2 or 3; and more preferably 1 or 2 substituent(s) L, which may be the same or different, wherein
L is selected from the group consisting of hydroxyl; C₁-C₆ alkyl; C₂-C₆ alkenyl; C₆-C₁₂ aryl, preferably C₆-C₁₀ aryl, more preferably C₆-C₇ aryl; C₅-C₁₂ heteroaryl, preferably C₅-C₁₀ heteroaryl, more preferably C₅-C₆ heteroaryl; where L may partially or completely be halogenated by fluorine, and where L may be bonded via a divalent bridging group —O—, and where two vicinal substituents L together may be (═O) or (═S);
   and wherein any two adjacent divalent moieties A, B and/or C, which belong either to the same monomeric unit U′ or to adjacent monomeric units U′ of the sulfonated polymer SP, may be covalently bonded to one another by a single carbon-carbon bond or by a divalent bridging group selected from the group consisting of —O—, —S—, —(C═O)—, —(C═O)O—, —O(C═O)—, and —S(═O)₂—. In this embodiment, the monomeric units U′ of the sulfonated polymer SP preferably comprise at least one moiety —SO₃H.

In a particularly preferred embodiment of the present invention, the monomeric units U′ of the sulfonated polymer SP comprise 1, 2, 3, 4 or 5 divalent moiety (moieties), selected from the group consisting of:
(A) divalent C₁-C₁₀ alkanediyl, preferably C₁-C₆ alkanediyl, and more preferably C₁-C₄ alkanediyl; and
(B) divalent C₆-C₁₅ aryl, preferably C₆-C₁₂ aryl, and more preferably C₆-C₁₀ aryl;
   wherein any of the divalent moieties A or B may be modified as defined above, with the proviso that 1, 2 or 3, preferably 1 or 2 of the divalent moieties A or B of the monomeric units U′ may comprise 1 or 2 substituent(s) L, which may be the same or different, wherein
L is selected from the group consisting of C₁-C₆ alkyl; preferably linear C₁-C₄ alkyl, in particular methyl, ethyl, propyl and butyl; C₆-C₇ aryl, preferably phenyl; C₅-C₆ heteroaryl; where L may partially or completely be halogenated by fluorine, and where L may be bonded via a divalent bridging group —O—;
   and wherein any two adjacent divalent moieties A and/or B, which belong either to the same monomeric unit U′ or to adjacent monomeric units U′ of the sulfonated polymer SP, may be covalently bonded to one another by a single carbon-carbon bond or by a divalent bridging group selected from the group consisting of —O—, —S—, —(C═O)—, and —S(═O)₂—. In this embodiment, the monomeric units U′ of the sulfonated polymer SP preferably comprise at least one moiety —SO₃H.

In another particularly preferred embodiment of the present invention, the monomeric units U′ of the sulfonated polymer SP comprise from 2 to 30, preferably from 2 to 25 diva-lent moieties A,

wherein A is divalent C₁-C₁₀ alkanediyl; preferably C₁-C₆ alkanediyl, more preferably C₂-C₄ alkanediyl;
wherein any of the divalent moieties A may be modified as defined above, with the proviso that 1, 2 or 3 of the divalent moieties A of the monomeric units U′ may comprise 1 or 2 substituent(s) L, which may be the same or different, wherein
L is selected from the group consisting of C₁-C₆ alkyl; C₆-C₇ aryl; C₅-C₆ heteroaryl; where L may partially or completely be halogenated by fluorine, and where L may be bonded via a divalent bridging group —O—;
   and wherein any two adjacent divalent moieties A, which belong either to the same monomeric unit U′ or to adjacent monomeric units U′ of the sulfonated polymer SP, may be covalently bonded to one another by a single carbon-carbon bond or by a divalent bridging group selected from the group consisting of —O—, —S—, —(C═O)—, and —S(═O)₂—. In this embodiment, preferably only one of the monomeric units U′ of the sulfonated polymer SP comprises a moiety —SO₃H.

In a very particularly preferred embodiment, the monomeric units U′ of the sulfonated polymer SP comprise from 2 to 30, preferably from 2 to 25 divalent moieties A, wherein A is C₂-C₄ alkanediyl, in particular ethanediyl, n-propanediyl, i-propanediyl, n-butanediyl, 1-butanediyl and t-butanediyl; especially ethanediyl, n-propanediyl and i-propanediyl. The aforementioned divalent moieties A preferably are partially or completely, more preferably completely, halogenated by fluorine. Preferably, in the monomeric units U′ at least two adjacent divalent moieties A, which belong to the same monomeric unit U′ of the sulfonated polymer SP, are covalently bonded to one another by a divalent bridging group selected from the group consisting of —O—, —S—, —(C═O)—, and —S(═O)₂—, preferably —O—. In this embodiment, preferably only one of the monomeric units U′ of the sulfonated polymer SP comprises a moiety —SO₃H.

In a preferred embodiment of the present invention, the polybenzimidazole polymer PBI and the sulfonated polymer SP form a miscible blend. Therefore, in a particularly preferred embodiment, the sulfonated polymer SP is selected from polymers which are miscible with the polybenzimidazole polymer PBI employed in the present invention. In particular, the sulfonated polymer SP is selected from the group consisting of perfluorosulfonic acid, sulfonated polystyrene, sulfonated poly(ether ether ketone), sulfonated poly(arylene ether ketone), sulfonated poly(ether ketone), sulfonated poly(ether ketone ketone), sulfonated poly(4-phenoxybenzoyl-1,4-phenylene), sulfonated polysulfones, sulfonated poly(phenylquinoxalines), sulfonated poly(2,6-diphenyl-4-phenylene oxide), and sulfonated polyphenylenesulfide.

In a very particularly preferred embodiment of the present invention, the sulfonated poly-mer SP is selected from the group consisting of:
perfluorosulfonic acid of formula (III):

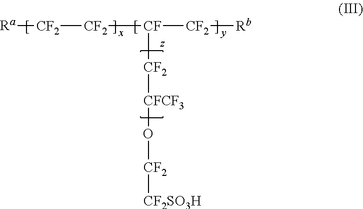

wherein x is an integer in the range of from 3 to 15, preferably from 3 to 10; y is 1, 2 or 3; and z is 0, 1, 2 or 3; and where R^{a} and R^{b} may be the same or different and are selected from the group consisting of fluorine or trifluorinemethyl.
sulfonated polystyrene having monomeric units of formula (IV):

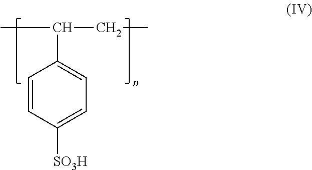

wherein n is an integer in the range of from 100 to 10,000;
sulfonated poly(ether ether ketone) having monomeric units of formula (V):

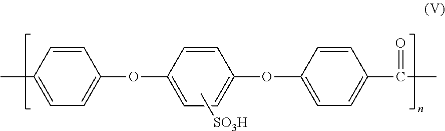

wherein n is an integer in the range of from 100 to 10,000;
sulfonated poly(arylene ether ketone) having monomeric units of formula (VI):

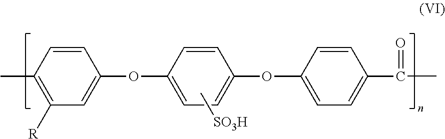

wherein n is an integer in the range of from 100 to 1,000; and R is selected from the group consisting of hydrogen; linear C₁-C₄ alkyl, in particular methanediyl, ethanediyl, propanediyl, and butanediyl; and C₇-C₁₀ arylalkyl, preferably phenyl carrying C₁-C₄ alkyl, preferably linear C₁-C₄ alkyl, in particular methyl phenyl, ethyl phenyl, n-propyl phenyl, and n-butyl phenyl;
sulfonated poly(ether ketone) having monomeric units of formula (VII):

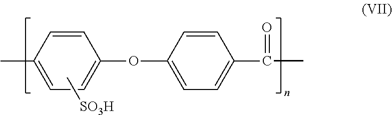

wherein n is an integer in the range of from 100 to 10,000;
sulfonated poly(ether ketone ketone) having monomeric units of formula (VIII):

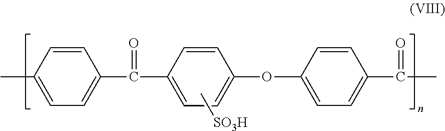

wherein n is an integer in the range of from 100 to 10,000;
sulfonated poly(4-phenoxybenzoyl-1,4-phenylene) having monomeric units of formula (IX):

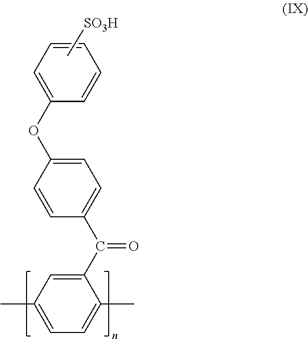

wherein n is an integer in the range of from 100 to 10,000;
sulfonated polysulfones having monomeric units of formula (X):

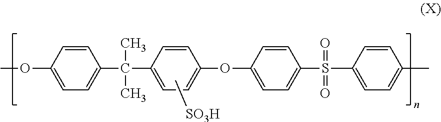

wherein n is an integer in the range of from 100 to 10,000;
sulfonated poly(phenylquinoxalines) having monomeric units of formula (XI):

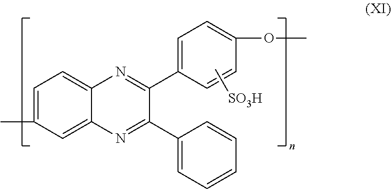

wherein n is an integer in the range of from 100 to 10,000;
sulfonated poly(2,6-diphenyl-4-phenylene oxide) having monomeric units of formula (XII):

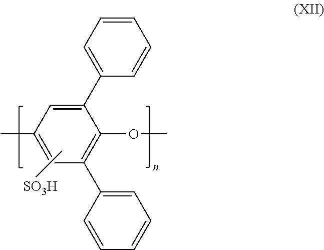

wherein n is an integer in the range of from 100 to 10,000;
sulfonated polyphenylenesulfide having monomeric units of formula (XIII):

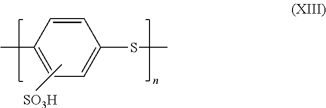

wherein n is an integer in the range of from 100 to 10,000.

In another preferred embodiment, the polybenzimidazole polymer PBI and/or the sulfonated polymer SP, independently from one another, each have a number average molecular weight M_{N} in the range of from about 500 to about 1,000,000. In another preferred embodiment, the polybenzimidazole polymer PBI and/or the sulfonated polymer SP, independently from one another, each have a weight average molecular weight M_{W} in the range of from about 500 to about 1,000,000; preferably in the range of from about 800 to about 1,000,000.

Generally, the membrane M may comprise in the range of from 0.1 to 25 wt.-%, preferably in the range of from 0.1 to 20 wt.-%, and more preferably in the range of from 1 to 20 wt.-% of the polybenzimidazole polymer PBI, based on the total weight of the polymers PBI and SP together. Generally, the membrane M may comprise in the range of from 75 to 99.9 wt.-%, preferably in the range of from 80 to 99.9 wt.-%, and more preferably in the range of from 80 to 99 wt.-% of the sulfonated polymer SP, based on the total weight of the polymers PBI and SP together.

Advantageously, the membrane M further comprises electron-deficient compounds, in particular at least one Boron-based electron-deficient compound BC. The electron-deficient compound BC for use in this invention may include inorganic and/or organic Boron-based compounds.

Preferably, the polybenzimidazole polymer PBI, the sulfonated polymer SP and, if appropriate, the Boron-based electron-deficient compound BC, form a miscible blend. Miscibility of these polymers is due to the acid-basic interaction between the basic Im cycle of the polybenzimidazole polymer and acidic sulfonic groups of the sulfonated polymer. In general, the polybenzimidazole polymer PBI, the sulfonated polymer SP and, if appropriate, the Boron-based electron-deficient compound BC, are homogenously distributed, dissolved or well dispersed within the polymer blend employed in the membrane M.

Generally, the membrane M comprises in the range of from 0.01 to 5 wt.-%, particularly in the range of from 0.01 to 1 wt.-%, more particularly in the range of from 0.1 to 0.5 wt.-% of the Boron-based electron-deficient compound BC, based on the total weight of the polymers PBI and SP together.

In a preferred embodiment, the membrane M comprises from 0.1 to 25 wt.-%, preferably from 9 to 20 wt.-% of the polybenzimidazole polymer PBI; wherein the membrane M comprises from 75 to 99.9 wt.-%, preferably from 80 to 91 wt.-% of the sulfonated polymer SP; and wherein the membrane M comprises from 0.01 to 1 wt.-%, preferably in the range of from 0.1 to 0.5 wt.-% of the Boron-based electron-deficient compound BC, in each case based on the total weight of the polymers PBI and SP together.

As has been stated above, the electron-deficient compound may be an inorganic Boron-based electron-deficient compound BC. Preferably, in this case BC is selected from the group consisting of B₂O₃, H₃BO₃ and BN.

As has been stated above, the electron-deficient compound may be an organic Boron-based electron-deficient compound BC. Preferably, in this case BC is selected from the group consisting of (CH₃O)₃B; (CF₃CH₂O)₃B; (C₃F₇CH₂O)₃B; [(CF₃)₂CHO]₃B; [(CF₃)₃CO]₃B; [(CF₃)₂C(C₆H₅)O]₃B; (C₆H_{S}O)₃B; (FC₆H₄O)₃B; (F₂C₆H₃O)₃B; (F₄C₆HO)₃B; (C₆F₅O)₃B; (CF₃C₆H₄O)₃B; [(CF₃)₂C₆H₃O]₃B; (C₆F₅)₃B; (C₆F₅)₃OB; (C₆F₄)(C₆F₅)O₂B; [(CF₃)₂CH]₂O₂B(C₆F₅); (C₆H₃F)(C₆H₃F₂)O₂B; (C₆H₃F)(C₆H₄CF₃)O₂B; (C₆H₃F)[C₆H₃(CF₃)₂]O₂B; (C₆F₄)(C₆H₄F)O₂B; (C₆F₄)(C₆H₃F₂)O₂B; (C₆F₄)(C₆H₄CF₃)O₂B; C₆F₄)[C₆H₄(CF₃)₂]O₂B; [(CF₃)₂CH]₂O₂B(C₆H₅); [(CF₃)₂C]₂O₂B(C₆H₃F₂); [(CF₃)₂CH]₂O₂B(C₆H₅); [(CF₃)₂CH]₂O₂B(C₆H₃F₂); [(CF₃)₂CH]O₂B(C₆F₅). The chemical formulae of these organic Boron-based electron-deficient compounds are listed as follows:

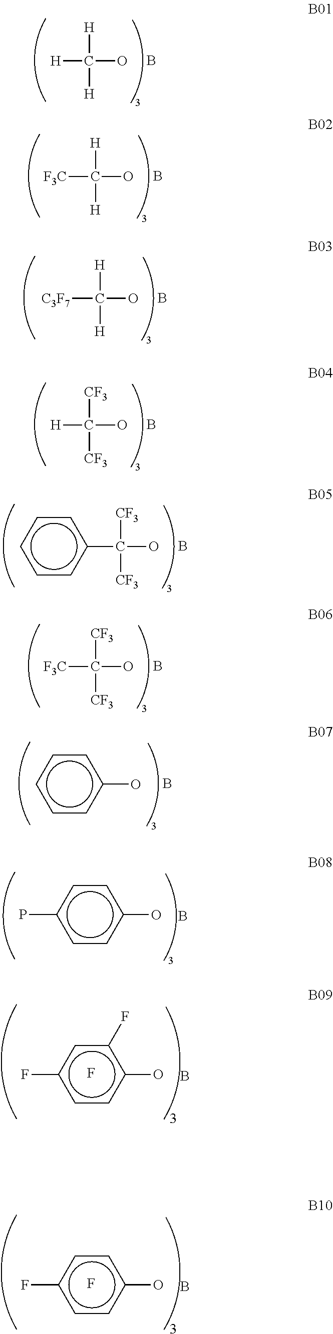

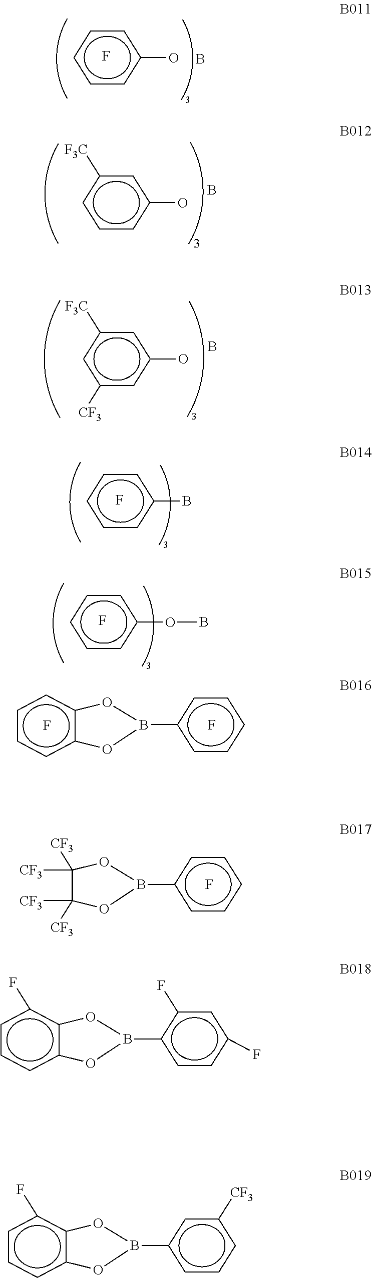

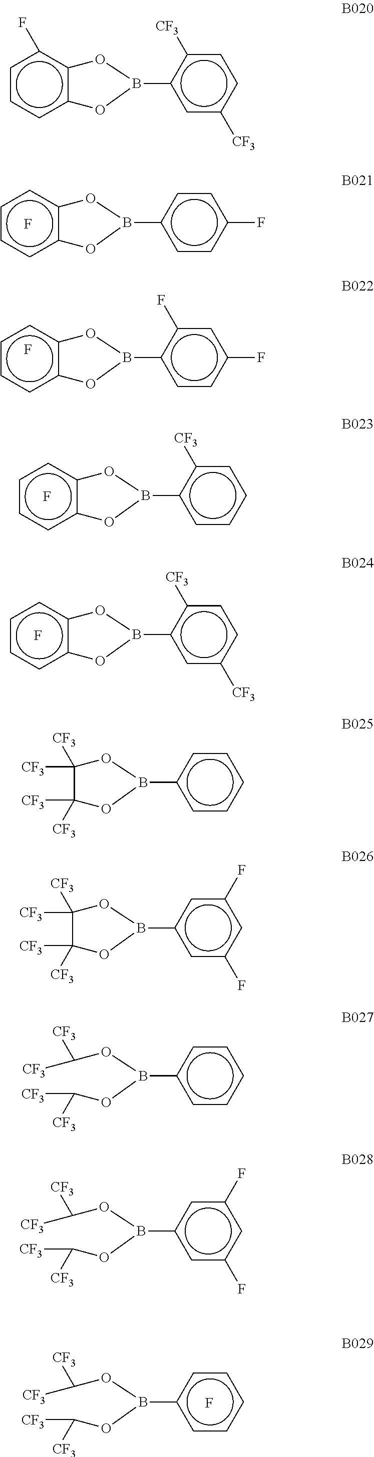

In another preferred embodiment, the membrane M according to the invention has a thickness in the range of from about 20 μm to about 200 μm, more preferably from about 50 μm to about 100 μm, under conditions where the membrane M is essentially free of water.

According to the invention, the membrane M exhibits a significant conductivity under conditions where the membrane M is essentially free of water (also referred to as anhydrous state). Usually, the water content of the membrane M at anhydrous state (in particular directly after production of the membrane M) is less than 0.5 wt.-%, and especially less than 0.1 wt.-%, based on the total weight of the membrane M. However, during operation of a fuel cell, anhydrous state usually means that water vaporizes from the membrane M at elevated temperatures (above 100° C.) without humidification of the reactant gas. In this case, the membrane M usually is not completely dehydrated (i.e. anhydrous), especially at temperatures below 130° C., due to the water electrochemically generated during fuel cell operation. Typically, in this context “essentially free of water” means that the membrane M has a water content of 10 wt.-% or less, based on the total weight of the membrane M. In a preferred embodiment, the membrane M according to the invention, under conditions where the membrane M is essentially free of water, has a water content of 5 wt.-% or less, more preferably 3 wt.-% or less, based on the total weight of the membrane M. In this con-text, it is understood that the reactant gas employed to feed an inventive proton exchange membrane fuel cell is not humidified; or the reactant gas is only humidified to an extent of at most 20 vol.-%, in particular at most 10 vol.-%, based on the total volume of the reactant gas.

In another aspect, the present invention relates to a proton exchange membrane fuel cell, in particular a polymer electrolyte membrane fuel cell (PEMFC) or a direct methanol fuel cell (DMFC), comprising a proton exchange membrane M as described herein, which is designed to operate under conditions where the membrane M is essentially free of water at a temperature of 100° C. or more, preferably in the range of from 100 to 250° C., more preferably in the range of from 100 to 225° C., and most preferably in the range of from 100 to 200° C., and wherein at said temperature the membrane M exhibits a proton conductivity of at least 1 S/cm, preferably at least 2×10⁻⁵ S/cm, and more preferably at least 5×10⁻⁵ S/cm, as measured by impedance method.

Such PEMFC and DMFC proton exchange membrane fuel cells typically include, in addition to the proton exchange membrane M according to the invention (also referred to as polymer electrolyte membrane), an anode (fuel electrode) and a cathode (oxidizing agent electrode). The membrane M is intermediated between the anode and the cathode. The anode generally includes a catalyst layer to promote the oxidation of a fuel, and the cathode generally includes a catalyst layer to promote the reduction of an oxidizing agent. Examples of fuel that may be supplied to the anode include hydrogen, a hydrogen-containing gas, a mixture of methanol vapor and water vapor, and an aqueous methanol solution. Examples of the oxidizing agent supplied to the cathode include oxygen, oxygen containing gas, and air. In this context, it is understood that the reactant gas employed to feed an inventive proton exchange membrane fuel cell is not humidified; or the reactant gas is only humidified to an extent of at most 20 vol.-%, in particular at most 10 vol.-%, based on the total volume of the reactant gas.

The PEMFC provided with a membrane M according to the invention can operate at temperatures of up to at least 170° C. and can tolerate up to at least 3 vol-% carbon monoxide in the fuel steam, so that hydrogen-rich gas from a fuel reformer can directly be used for generation of electricity. The DMFC provided with a membrane M according to the invention can be operated at temperatures up to at least 150° C., exhibit better performance compared with the Nafion membranes.

In another aspect, the present invention relates to a proton exchange membrane M as has been proposed for use according to the present invention, wherein the membrane M comprises from 0.1 to 30 wt.-%, e.g. 0.1 to 20 wt.-%, preferably from 5 to 25 wt.-% of the poly-benzimidazole polymer PBI; and wherein the membrane M comprises from 70 to 99.9 wt.-%, e.g. from 80 to 99.9 wt.-%, preferably from 75 to 95 wt.-% of the sulfonated polymer SP, in each case based on the total weight of the polymers PBI and SP together. Preferably, the membrane M comprises from 9 to 25 wt.-%, more preferably from 9 to 20 wt.-% of the polybenzimidazole polymer PBI; wherein the membrane M comprises from 75 to 91 wt.-%, more preferably from 80 to 91 wt.-% of the sulfonated polymer SP, in each case based on the total weight of the polymers PBI and SP together.

In a preferred embodiment, the membrane M according to the invention further comprises from 0.01 to 1.5 wt.-%, more preferably from 0.05 to 1 wt.-%, even more preferably from 0.05 to 0.5 wt.-%, and most preferably from 0.1 to 0.5 wt.-% of the Boron-based electron-deficient compound BC, based on the total weight of the polymers PBI and SP together.

In still another aspect, the present invention relates to a method for the production of a proton exchange membrane M according to the present invention.

The polybenzimidazole polymers PBI employed as starting materials in the production of the membranes M can be prepared by methods known in the art.

Polybenzimidazoles PBI used as starting compounds in the preparation method described herein are polybenzimidazoles and related families of compounds (see e.g., U.S. Pat. Nos. 4,814,399; 5,525,436; and 5,599,639). More specific examples of polybenzimidazoles, typically with an average molecular weight between 1,000 and 100,000, are poly-2,2′-(m-phenylene)-5,5′-bibenzimidazole; poly-2,2′-(pyridylene-3″,5″)-bibenzimidazole; poly-2,2′-(furylene-2″,5″)-5,5′-bibenzimidazole; poly-2,2′-(naphthalene-1″,6″)-5,5′-bibenzimidazole; poly-2,2′-(biphenylene-4″,4″)-5,5′-bibenzimidazole; poly-2,2′-amylene)-5,5′-bibenzimidazole; poly-2,2′-octamethylene-5,5′-bibenzimidazole; poly-2,6′-(m-phenylene)diimidazobenzene; poly-(1-(4,4′-diphenylether)-5-oxybenzimidazole)-benzimidazole; poly-(1-(2-pyridine)-5-oxybenzimidazole)-benzimidazole; poly-(3-(4-(6-(1-benzimidazol-5-yloxy)-1-benzimidazol-2-yl)phenyl)-3-phenylisobenzofuran-1(3H)-one) and polybenzimidazole. These polymers may be prepared from an aromatic diacid and an aromatic tetramine as described in the above US patents.

The most preferred polymer is poly 2,2′-(m-phenylene)-5,5′-bibenzimidazole product, PBI, known as Celazole™ provided by Hoechst Celanese. This polybenzimidazole is an amorphous thermoplastic polymer with a glass transition temperature of 425-436° C.

The sulfonated polymers SP employed as starting materials in the production of the membranes M are commercially available, such as Nafion®, and/or can be prepared by methods known in the art, such as polymerization methods like solution polymerization and emulsion polymerization.

In particular, it is referred to synthesis methods for sulfonated polymers SP such as:
perfluorosulfonic acid, e.g. as described in Fermandez, R. E. In Polymer Data Handbook; Mark, J. E., Ed.; Oxford University Press: New York, 1999; p 233;
sulfonated polystyrene, e.g. as described in J. P. Shin, B. J. Chang, J. H. Kim, S. B. Lee, D. H. Suh, J. Membrane Science, 251 (1-2) (2005) 247;
sulfonated poly(ether ether ketone), e.g. as described in Bauer, B.; Jones, D. J.; Roziere, J.; Tchicaya, L.; Alberti, G.; et. al. J. New Mater. Electrochem. Syst. 3 (2000) 93;
sulfonated poly(arylene ether ketone), e.g. as described in Rikukawa, M.; Sanui, K. Prog. Polym. Sci. 25 (2000) 1463;
sulfonated poly(ether ketone), e.g. as described in Ise, M.; Kreuer, K. D.; Maier, J. Solid State Ionics 125 (1999) 213;
sulfonated poly(ether ketone ketone), e.g. as described in Jin, X.; Bishop, M. T.; Ellis, T. S.; Karasz, F. E. Br. Polymer J. 17 (1985) 4;
sulfonated poly(4-phenoxybenzoyl-1,4-phenylene), e.g. as described in Kobayashi, T.; Rikukawa, M.; Sanui, K.; Ogata, N. Solid State Ionics 106 (1998) 219;
sulfonated polysulfones, e.g. as described in Chen, M. H.; Chiao, T.; Tseng, T. W. J. Appl. Polym. Sci. 61 (1996) 1205;
sulfonated poly(phenylquinoxalines), e.g. as described in Kopitzke, R. W; Linkous, C. A.; Nelson, G. L. J. Polym. Sci. 36 (1998) 1197;
sulfonated poly(2,6-diphenyl-4-phenylene oxide), e.g. as described in Kosmala, B.; Schauer, J. J. Appl. Polym. Sci. 85 (2002) 1118;
sulfonated polyphenylenesulfide e.g. as described in Miyatake, K.; lyotani, H.; Yamamoto, K.; Tscuchida, E. Macromolecules 29 (1996) 6969.

The Boron-based electron-deficient compounds BC employed as starting materials in the production of the membranes M are commercially available. More specific examples of BC are B₂O₃, H₃BO₃, BN, (CH₃O)₃B; (CF₃CH₂O)₃B; (C₃F₇CH₂O)₃B; [(CF₃)₂CHO]₃B; [(CF₃)₃CO]₃B; [(CF₃)₂C(C₆H₅)O]₃B; (C₆H₅O)₃B; (FC₆H₄O)₃B; (F₂C₆H₃O)₃B; (F₄C₆HO)₃B; (C₆F₅O)₃B; (CF₃C₆H₄O)₃B; [(CF₃)₂C₆H₃O]₃B; (C₆F₅)₃B; (C₆F₅)₃OB; (C₆F₄)(C₆F₅)O₂B; [(CF₃)₂C]₂O₂B(C₆F₅); (C₆H₃F)(C₆H₃F₂)O₂B; (C₆H₃F)(C₆H₄CF₃)O₂B; (C₆H₃F)[C₆H₃(CF₃)₂]O₂B; (C₆F₄)(C₆H₄F)O₂B; (C₆F₄)(C₆H₃F₂)O₂B; (C₆F₄)(C₆H₄CF₃)O₂B; (C₆F₄)[C₆H₄(CF₃)₂]O₂B; [(CF₃)₂C]₂O₂B(C₆H₅); [(CF₃)₂C]₂O₂B(C₆H₃F₂); [(CF₃)₂CH]₂O₂B(C₆H₅); [(CF₃)₂CH]₂O₂B(C₆H₃F₂); [(CF₃)₂CH]O₂B(C₆F₅).

In the method for the production of a membrane M according to the present invention, typically, before preparation of a membrane for the polymer electrolyte, a powder of a polybenzimidazole polymer PBI (e.g. a grain size of similar 100 mesh) is mixed with a suitable organic solvent, such as N,N-dimethylacetamide (DMAc), N,N-dimethylformamide (DMF), N-methylpyrrolidone (NMP), dimethylsulfoxide (DMSO) or the like. The mixture obtained usually contains the polybenzimidazole polymer PBI in the range of from 1 to 25 wt.-%, preferably in the range of from 5 to 20 wt.-%, based on the total weight of the mixture. Preferably, the mixture obtained is placed in a sealed reactor, such as a stainless steel bomb reactor. Typically, a stabilizer, such as lithium chloride, is added. Oxygen is preferably excluded from the mixture, e.g. by bubbling an inert gas like argon through the mixture. The reactor is advantageously closed and placed in a rotating oven for homogeneousness. Usually, the mixture is then heated, in particular to a temperature in the range of from 150 to 300° C., preferably in the range of from 200 to 250° C. Heating at the aforementioned temperature generally is carried out for e.g. from 0.5 to 20 h, preferably from 1 to 10 h, and more preferably from 3 to 5 hours. Optionally, the mixture obtained may be diluted before mixing it with a sulfonated polymer SP, such that a desired content of polybenzimidazole polymer PBI is achieved. Suitable solvents for dilution comprise N,N-dimethylacetamide (DMAc), N,N-dimethylformamide (DMF), N-methylpyrrolidone (NMP), dimethylsulfoxide (DMSO) and the like. The mixture obtained, which is used for mixing it with a sulfonated polymer SP, usually contains the polybenzimidazole polymer PBI in the range of from 1 to 15 wt.-%, preferably in the range of from 5 to 10 wt.-%, based on the total weight of the mixture.

The sulfonated polymer SP is typically dissolved in a suitable organic solvent, such as N,N-dimethylacetamide (DMAc), N,N-dimethylformamide (DMF), N-methylpyrrolidone (NMP), dimethylsulfoxide (DMSO) or the like. The mixture obtained, which is used for mixing it with the polybenzimidazole polymer PBI, usually contains the sulfonated polymer SP in the range of from 1 to 15 wt.-%, preferably in the range of from 5 to 10 wt.-%, based on the total weight of the mixture.

The Boron-based electron-deficient compound BC, if appropriate, is typically dispersed or dissolved in a suitable organic solvent, such as N,N-dimethylacetamide (DMAc), N,N-dimethylformamide (DMF), N-methylpyrrolidone (NMP), dimethylsulfoxide (DMSO), or the like. The mixture obtained, which is used for mixing it with the polybenzimidazole polymer PBI and the sulfonated polymer SP, usually contains the compound BC in the range of from 0.1 to 5 wt.-%, preferably in the range of from 0.5 to 2 wt.-%, based on the total weight of the mixture.

Next, the solutions of the polybenzimidazole polymer PBI, the sulfonated polymer SP and, if appropriate, the Boron-based electron-deficient compound BC, are mixed in a desired ratio, e.g. in the range of from 1:99:0.01 to 30:70:1, preferably in the range of from 2:98.9:0.1 to 25:75:1, and more preferably in the range of from 9:91:0.1 to 20:80:0.5.

Next, the solution obtained or a certain amount thereof, typically is applied to a substrate, in particular a flat substrate. For example, the solution is poured into a Teflon® dish with a glass bottom. The substrate with the solution applied thereon is heated, e.g. to a tempera-ture in the range of from 50 to 150° C., particularly in the range of from 80 to 120° C. Heating may take place for a period of time e.g. in the range of from about 10 to about 20 hours, preferably under vacuum, until complete evaporation of the solvents. Optionally, additional heating may be carried out at a higher temperature in the presence of oxygen, e.g. in air, in the range of from 130 to 180° C., particularly in the range of from 140 to 160° C. In general, the additional heating may be carried out for a period of time of from 5 min to 5 h, in particular for about 2 hours.

Advantageously, the membrane film obtained is treated with an oxidizing agent, such as H₂O₂, e.g. in the form of a 5 wt.-% solution of H₂O₂. Subsequently, the membrane film obtained is treated with an inorganic acid, such as H₂SO₄, e.g. in the form of a 1 M H₂SO₄ solution. Preferably, the aforementioned treatments in each case are carried out at an elevated temperature, e.g. in the range of from 50 to 120° C., particularly in the range of from 60 to 100° C. In general, the aforementioned treatments in each case may be carried out for a period of time of from 5 min to 2 h, in particular for about half an hour.

Advantageously, the membranes are heated in a purified solvent, such as deionized water, e.g. in boiling deionized water, in order to remove any residual solvent and/or stabilising salts. In general, the aforementioned heating may be carried out for a period of time of from 5 min to 2 h, in particular for about half an hour. Finally, the membranes obtained are dried, e.g. at ambient temperature, optionally under vacuum.

In a preferred embodiment of the present invention, the method for the production of a proton exchange membrane M as described herein, comprises the following steps:
(i) providing a solution of a polybenzimidazole polymer PBI, as defined hereinbefore, a sulfonated polymer SP, as defined hereinbefore, and optionally of a Boron-based electron-deficient compound BC, as defined hereinbefore, in an organic solvent OS, wherein the weight ratio of PBI:SP is in the range of from 1:99 to 20:80, preferably in the range of from 2:98 to 20:80, or, if appropriate, wherein the weight ratio of PBI:SP:BC is in the range of from 1:99:0.01 to 25:75:1, preferably in the range of from 2:98:0.1 to 20:80:0.5, whereby a reaction mixture RM is obtained;
(ii) applying the reaction mixture RM obtained in step (i) to a substrate S, preferably a flat substrate; and
(iii) heating the substrate S obtained in step (ii), optionally under vacuum, to a tempera-ture of at least 50° C., preferably in the range of from 50 to 120° C., such that essentially all solvents are evaporated from the reaction mixture RM applied on the substrate S, whereby a membrane film MF is obtained, and subsequently heating the membrane film MF thus obtained to a temperature of at least 130° C., particularly in the range of from 130 to 180° C., more particularly in the range of from 140 to 160° C., preferably in air.

In a particularly preferred embodiment of the present invention, the above method for the production of a proton exchange membrane M as described herein, further comprises the following step:
(iv) treating the membrane film MF obtained in step (iii) with an oxidizing agent, such as H₂O₂, and subsequently with an inorganic acid, such as H₂SO₄, preferably in each case at an elevated temperature, whereby a membrane film MF′ is obtained.

In a very particularly preferred embodiment of the present invention, the above method for the production of a proton exchange membrane M as described herein, further comprises the following step:
(v) treating the membrane film MF′ obtained in step (iv) with a purified solvent, preferably purified H₂O, at an elevated temperature, and subsequently drying the membrane film MF′, preferably under high vacuum, whereby a membrane M is obtained.

Suitable organic solvents OS in step (i) include N,N-dimethyl acetamide (DMAc), N,N-dimethyl formamide (DMF), N-methylpyrrolidone (NMP), and dimethyl sulfoxide (DMSO), and mixtures thereof. Generally, the organic solvent OS is used in pure grade quality. Thus, the residual content of water in the organic solvent OS usually is less than 0.1 wt.-%, based on the total weight of the organic solvent OS.

Evaporation of the solvent OS in step (iii) can advantageously be achieved by applying vacuum, in particular high vacuum.

A suitable heating time in step (iii) for heating the membrane film MF to a temperature of at least 130° C. is about 2 hours.

Suitable inorganic acids in step (iv) include H₂SO₄, HCl and H₃PO₄.

The elevated temperature in step (iv) typically is in the range of from 60° C. to 120° C., in particular from 80 to 100° C.

The elevated temperature in step (v) typically is in the range of from 80° C. to 120° C., in particular from 80 to 100° C.

Drying of the membrane film MF′ in step (v) is advantageously carried out by applying vacuum, in particular high vacuum.

The present invention provides a polybenzimidazole polymer PBI/sulfonated polymer SP blend membrane, and in particular a polybenzimidazole polymer PBI/sulfonated polymer SP/Boron-based electron-deficient compound BC blend membrane. The resulting PBI/SP blend membranes usually contain from 1 to 20 wt.-% polybenzimidazole polymer PBI, from 80 to 99 wt.-% sulfonated polymer SP, based on the total weight of the membrane M. The resulting PBI/SP/BC blend membranes usually contain from 0.1 to 0.5 wt.-% Boron-based electron-deficient compound BC, based on the total weight of the membrane M. The residual content of water in the membrane M finally obtained (directly after production of the membrane) usually is less than 0.5 wt.-%, in particular less than 0.25 wt.-%, and more particularly less than 0.1 wt.-%, based on the total weight of the membrane M. The PBI/SP and PBI/SP/BC polymer blend membranes of the present invention exhibit relative high proton conductivity (5×10⁻⁵−5×10⁻³ S/cm) at high temperature (100-200° C.) and anhydrous state. PBI/SP and PBI/SP/BC polymer blend of the invention are particularly well adapted for use as a proton exchange membrane in a high temperature PEMFC and DMFC because it is essentially free of water and has high proton conductivity at high temperature. Therefore, it allows for operation of fuell cells with minimized humidification or even without humidification of the reactant gas. Typically, in this context “essentially free of water” means that the membrane M has a water content of 10 wt.-% or less, preferably 5 wt.-% or less, more preferably 3 wt.-% or less, based on the total weight of the membrane M. Moreover, in this context, it is understood that the reactant gas employed to feed an inventive proton exchange membrane fuel cell is not humidified; or the reactant gas is only humidified to an extent of at most 20 vol.-%, in particular at most 10 vol.-%, based on the total volume of the reactant gas.

Consequently, the availability of proton conducting membranes retaining satisfactory conductivity at high temperature (typically 100-200° C.) without humidification could permit the realization of PEMFC and DMFC which are of special interest for the co-generation stationary power plant application and electric vehicle.

One of skill in the art may readily select any other suitable sulfonated polymer. The present invention is not limited to the choice of sulfonated polymer, provided that the sulfonated polymer can be blended with a polybenzimidazole polymer, such that a miscible matrix is formed.

### EXAMPLES

The following examples illustrate the preferred compositions and methods of the invention, using a commercial polybenzimidazole (2,2′-(m-phenylene)-5,5′-bibenzimidazole, known as Celazole™ provided by Hoechst Celanese) as exemplified PBI polymer and (C₆F₅)₃B (TPFPB) as exemplified Boron-based electron-deficient compound BC. Through-out examples 12 to 22, varying weight percent of the compound BC may be achieved, which are typically in a range of from about 0.1 to about 0.5 wt-%, based on the total weight of the PBI polymer and the sulfonated compound SP. Proton conductivity values typically are obtained in a temperature range of from 100 to 200° C. Throughout the following examples, varying proton conductivity values may be obtained, which are typically at least about 5×10⁻⁵ S/cm, and which often are in a range of from about 10⁻⁴ to about 5×10⁻³ S/cm, under conditions where the membrane M is essentially free of water. These examples are illustrative only and are not intended to limit the scope of the invention.

### Example 1

An exemplary PBI/Nafion® (see formula III, wherein x=10, y=1 and z=0) blend membrane of this invention is prepared as follows. A 5 wt.-% PBI/DMAc solution is mixed with a 5 wt.-% Nafion®/DMAc solution in a weight ratio of 10:90. A certain amount of this solution is poured into a Teflon dish with a glass bottom and placed in a vacuum oven at 80° C. for about 10 hours until complete evaporation of the solvents. Then the membrane is heated at 160° C. in air for 2 hours. The Nafion®/PBI blend membrane is then treated in 5 wt.-% H₂O₂ solution and in 1 M H₂SO₄ solution at 80° C. for half an hour, respectively. Finally, the membranes are heated in boiling deionized water for half an hour to remove the residual solvent and stabilising salts, and then dried at ambient temperature.

### Example 2

An exemplary PBI/sulfonated poly(ether ether ketone) (SPEEK, see formula V, wherein n=5,000) blend membrane of this invention is prepared by solvent casting method. A 5 wt.-% PBI/DMAc solution is mixed with a 5 wt.-% SPEEK/NMP solution in a weight ratio of 10:90. A certain amount of this solution is poured into a Teflon dish with a glass bottom and placed in a vacuum oven at 60° C. for about 15 hours until complete evaporation of the solvents. Then the membrane is heated at 100° C. in air for half an hour. The SPEEK/PBI blend membrane is then treated in a 5 wt.-% H₂O₂ solution and in a 1 M H₂SO₄ solution at 80° C. for half an hour, respectively. Finally, the membranes are heated in boiling deionized water for half an hour to remove the residual solvent and stabilising salts, and then dried at ambient temperature.

### Example 3

A 5 wt.-% PBI solution in DMF is mixed with a 5 wt.-% sulfonated poly(arylene ether ketone) (SPAEK, see formula VI, wherein n=10,000) solution in a weight ratio of 15:85. PBI/SPAEK blend membrane is prepared by solvent casting method as described in example 1. After the solvent is evaporated completely, the polymer membrane is washed with distilled water at 80° C. to remove the residual solvent and stabilising salts.

### Example 4

A 5 wt.-% PBI solution in DMSO is mixed with a 5 wt.-% sulfonated poly(ether ketone) (SPEK, see formula VII, wherein n=5,000) solution in a weight ratio of 20:80. PBI/SPEK blend membrane is prepared by solvent casting method as described in example 1. After the solvent is evaporated completely, the polymer membrane is washed with distilled water at 80° C. to remove the residual solvent and stabilising salts.

### Example 5

A 5 wt.-% PBI solution in DMAc is mixed with a 5 wt.-% sulfonated poly(ether ketone ketone) (SPEKK, see formula VIII, wherein n=2,000) solution in a weight ratio of 15 to 85. PBI/SPEK blend membrane is prepared by solvent casting method as described in example 1. After the solvent is evaporated completely, the polymer membrane is washed with distilled water at 80° C. to remove the residual solvent and stabilising salts.

### Example 6

A 5 wt.-% PBI solution in NMP is mixed with a 5 wt.-% sulfonated polysulfone (SPSF, see formula X, wherein n=5,000) solution in a weight ratio of 10:90. PBI/SPSF blend membrane is prepared by solvent casting method as described in example 1.

### Example 7

A 5 wt.-% PBI solution in DMF is mixed with a 5 wt.-% sulfonated poly(4-phenoxybenzoyl-1,4-phenylene) (SPPBP, see formula IX, wherein n=5,000) solution in a weight ratio of 12:88. PBI/SPSF blend membrane is prepared by solvent casting method as described in example 1.

### Example 8

A 5 wt.-% PBI solution in DMSO is mixed with a 5 wt.-% sulfonated poly(phenylquinoxalines) (SPPQ, see formula XI, wherein n=10,000) solution in a weight ratio of 15:85. PBI/SPSF blend membrane is prepared by solvent casting method as de-scribed in example 1.

### Example 9

A 5 wt.-% PBI solution in DMAc is mixed with a 5 wt.-% sulfonated polyphenylenesulfide (SPPS, see formula XIII, wherein n=1,000) solution in a weight ratio of 5:95. PBI/SPSF blend membrane is prepared by solvent casting method as described in example 1.

### Example 10

A 5 wt.-% PBI solution in DMF is mixed with a 5 wt.-% sulfonated polystyrene (SPS, see formula IV, wherein n=8,000) solution in a weight ratio of 10:90. PBI/SPSF blend membrane is prepared by solvent casting method as described in example 1.

### Example 11

A 5 wt.-% PBI solution in DMAc is mixed with a 5 wt.-% sulfonated poly(2,6-diphenyl-4-phenylene oxide) (SPDPO, see formula XII, wherein n=4,000) solution in a weight ratio of 15:85. PBI/SPSF blend membrane is prepared by solvent casting method as described in example 1.

### Example 12

An exemplary PBI/Nafion®/TPFPB (Nafion®, see formula III, wherein x=10, y=1 and z=0) blend membrane of this invention is prepared as follows. A 5 wt.-% PBI/DMAc solution is mixed with a 5 wt.-% Nafion®/DMAc solution and 1 wt.-% TPFPB/DMAc in a weight ratio of 9:91:0.5. A certain amount of this solution is poured into a Teflon dish with a glass bot-tom and placed in a vacuum oven at 80° C. for about 10 hours until complete evaporation of the solvents. Then the membrane is heated at 160° C. in air for 2 hours. The Nafion®/PBI/TPFPB blend membrane is then treated in 5 wt.-% H₂O₂ solution and in 1 M H₂SO₄ solution at 80° C. for half an hour, respectively. Finally, the membranes are heated in boiling deionized water for half an hour to remove the residual solvent and stabilising salts, and then dried at ambient temperature.

### Example 13

An exemplary PBI/sulfonated poly(ether ether ketone) (SPEEK, see formula V, wherein n=5,000)/TPFPB blend membrane of this invention is prepared by solvent casting method. A 5 wt.-% PBI/DMAc solution is mixed with a 5 wt.-% SPEEK/NMP solution and 1 wt.-% BC/NMP solution in a weight ratio of 10:90:0.1. A certain amount of this solution is poured into a Teflon dish with a glass bottom and placed in a vacuum oven at 60° C. for about 15 hours until complete evaporation of the solvents. Then the membrane is heated at 100° C. in air for half an hour. The SPEEK/PBUTPFPB blend membrane is then treated in a 5 wt.-H₂O₂ solution and in a 1 M H₂SO₄ solution at 80° C. for half an hour, respectively. Finally, the membranes are heated in boiling deionized water for half an hour to remove the residual solvent and stabilising salts, and then dried at ambient temperature.

### Example 14

A 5 wt.-% PBI solution in DMF is mixed with a 5 wt.-% sulfonated poly(arylene ether ketone) (SPAEK, see formula VI, wherein n=10,000) solution and 1 wt.-% TPFPB/DMF solution in a weight ratio of 15:85:0.2. PBI/SPAEK/TPFPB blend membrane is prepared by solvent casting method as described in example 1. After the solvent is evaporated completely, the polymer membrane is washed with distilled water at 80° C. to remove the residual solvent and stabilising salts.

### Example 15

A 5 wt.-% PBI solution in DMSO is mixed with a 5 wt.-% sulfonated poly(ether ketone) (SPEK, see formula VII, wherein n=5,000) solution and 1 wt.-% TPFPB/DMSO solution in a weight ratio of 20:80:0.3. PBUSPEK/TPFPB blend membrane is prepared by solvent casting method as described in example 1. After the solvent is evaporated completely, the polymer membrane is washed with distilled water at 80° C. to remove the residual solvent and stabilising salts.

### Example 16

A 5 wt.-% PBI solution in DMAc is mixed with a 5 wt.-% sulfonated poly(ether ketone ketone) (SPEKK, see formula VIII, wherein n=2,000) and 1 wt.-% TPFPB/DMAC solution solution in a weight ratio of 15:85:0.4. PBI/SPEK/TPFPB blend membrane is prepared by solvent casting method as described in example 1. After the solvent is evaporated completely, the polymer membrane is washed with distilled water at 80° C. to remove the residual solvent and stabilising salts.

### Example 17

A 5 wt.-% PBI solution in NMP is mixed with a 5 wt.-% sulfonated polysulfone (SPSF, see formula X, wherein n=5,000) solution and 1 wt.-% TPFPB/NMP solution in a weight ratio of 10:90:0.5. PBI/SPSF/TPFPB blend membrane is prepared by solvent casting method as described in example 1.

### Example 18

A 5 wt.-% PBI solution in DMF is mixed with a 5 wt.-% sulfonated poly(4-phenoxybenzoyl-1,4-phenylene) (SPPBP, see formula IX, wherein n=5,000) solution and 1 wt.-% TPFPB/DMF solution in a weight ratio of 12:88:0.3. PBI/SPSF/TPFPB blend membrane is prepared by solvent casting method as described in example 1.

### Example 19

A 5 wt.-% PBI solution in DMSO is mixed with a 5 wt.-% sulfonated poly(phenylquinoxalines) (SPPQ, see formula XI, wherein n=10,000) solution and 1 wt.-% TPFPB/DMSO solution in a weight ratio of 15:85:0.2. PBI/SPSF/TPFPB blend membrane is prepared by solvent casting method as described in example 1.

### Example 20

A 5 wt.-% PBI solution in DMAc is mixed with a 5 wt.-% sulfonated polyphenylenesulfide (SPPS, see formula XIII, wherein n=1,000) solution and 1 wt.-% TPFPB/DMAc solution in a weight ratio of 5:95:0.4. PBI/SPSF/TPFPB blend membrane is prepared by solvent casting method as described in example 1.

### Example 21

A 5 wt.-% PBI solution in DMF is mixed with a 5 wt.-% sulfonated polystyrene (SPS, see formula IV, wherein n=8,000) solution and 1 wt.-% TPFPB/DMF solution in a weight ratio of 10:90:0.1. PBI/SPSF/TPFPB blend membrane is prepared by solvent casting method as described in example 1.

### Example 22

A 5 wt.-% PBI solution in DMAc is mixed with a 5 wt.-% sulfonated poly(2,6-diphenyl-4-phenylene oxide) (SPDPO, see formula XII, wherein n=4,000) solution and 1 wt.-% TPFPB/DMAc solution in a weight ratio of 15:85:0.2. PBUSPSF/TPFPB blend membrane is prepared by solvent casting method as described in example 1.

1. A proton exchange membrane M for proton exchange membrane fuel cells, the membrane M comprises a blend of
(I) at least one polybenzimidazole polymer PBI which comprises, in polymerized form, at least 90 mol-% monomeric units U of formula (I) and/or (II), based on the total amount of monomeric units of the polybenzimidazole polymer PBI, 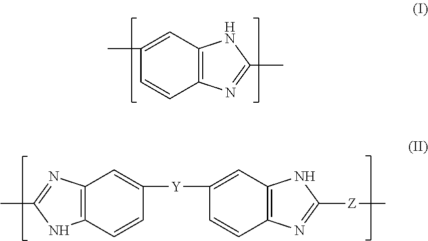
wherein
Y is a substituted element selected from O and S; or Y is a single carbon-carbon bond;
Z is selected from the group consisting of divalent C₁-C₁₀ alkanediyl; divalent C₂-C₁₀ alkenediyl; divalent C₆-C₁₅ aryl; divalent C₅-C₁₅ heteroaryl; divalent C₅-C₁₅ heterocyclyl; divalent C₆-C₁₉ aryl sulfone; and divalent C₆-C₁₉ aryl ether; and
wherein the total amount of monomeric units U in the polybenzimidazole polymer PBI is from about 100 to about 10,000; and
(II) at least one sulfonated polymer SP, which comprises, in polymerized form, at least 50 mol-% monomeric units U′, based on the total amount of monomeric units of the sulfonated polymer SP, wherein at least one of the monomeric units U′ carries at least one moiety —SO₃H;
wherein the membrane M is essentially free of water and exhibits a proton conductivity at a temperature of 100° C. or more of at least 10⁻⁵ S/cm, as measured by impedance method.

2. A membrane M according to claim 1, wherein the membrane M further comprises at least one Boron-based electron-deficient compound BC.

3. A membrane M according to claim 2, wherein the Boron-based electron-deficient compound BC is an inorganic compound.

4. A membrane M according to claim 2, wherein the Boron-based electron-deficient compound BC is an organic compound; selected from the group consisting of (CH₃O)₃B; (CF₃CH₂O)₃B; (C₃F₇CH₂O)₃B; [(CF₃)₂CHO]₃B; [(CF₃)₃CO]₃B; [(CF₃)₂C(C₆H₅)O]₃B; (C₆H₅O)₃B; (FC₆H₄O)₃B; (F₂C₆H₃O)₃B; (F₄C₆HO)₃B; (C₆F₅O)₃B; (CF₃C₆H₄O)₃B; [(CF₃)₂C₆H₃O]₃B; (C₆F₅)₃B; (C₆F₅)₃OB; (C₆F₄)(C₆F₅)O₂B; [(CF₃)₂C]₂O₂B(C₆F₅); (C₆H₃F)(C₆H₃F₂)O₂B; (C₆H₃F)(C₆H₄CF₃)O₂B; (C₆H₃F) [C₆H₃(CF₃)₂]O₂B; (C₆F₄)(C₆H₄F)O₂B; (C₆F₄)(C₆H₃F₂)O₂B; (C₆F₄)(C₆H₄CF₃)O₂B; (C₆F₄)[C₆H₄(CF₃)₂]O₂B; [(CF₃)₂C]₂O₂B(C₆H₅); [(CF₃)₂C]₂O₂B(C₆H₃F₂); [(CF₃)₂CH]₂O₂B(C₆H₅); [(CF₃)₂CH]₂O₂B(C₆H₃F₂); [(CF₃)₂CH]O₂B(C₆F₅).

5. A membrane M according to claim 1, wherein the polybenzimidazole polymer PBI and the sulfonated polymer SP form a miscible blend.

6. A membrane M according to claim 1, wherein the membrane M comprises from 0.1 to 20 wt.-% of the polybenzimidazole polymer PBI; and wherein the membrane M comprises from 80 to 99.9 wt.-% of the sulfonated polymer SP, in each case based on the total weight of the polymers PBI and SP together.

7. A membrane M according to claim 2, wherein the membrane M comprises from 0.01 to 1 wt.-% of the Boron-based electron-deficient compound BC, based on the total weight of the polymers PBI and SP together.

8. A membrane M according to claim 1, wherein the polybenzimidazole polymer PBI comprises, in polymerized form, at least 90 mol-% monomeric units U of formula (I), based on the total amount of monomeric units in the polybenzimidazole polymer PBI, wherein the monomeric units U of formula (I) may be linked to one another, independently from one another, by a moiety Y or Z, as defined in claim 1.

9. A membrane M according to claim 1, wherein the polybenzimidazole polymer PBI comprises, in polymerized form, at least 90 mol-% monomeric units U of formula (II), based on the total amount of monomeric units in the polybenzimidazole polymer PBI.

10. A membrane M according to claim 1, wherein Y is O or a single carbon-carbon bond.

11. A membrane M according to claim 1, wherein Z is selected from the group consisting of phenylene, pyridylene, furylene, naphthalene, biphenylene, amylene and octamethylene.

12. A membrane M according to claim 1, wherein the polybenzimidazole polymer PBI is selected from the group consisting of poly-2,2′-(m-phenylene)-5,5′-bibenzimidazole; poly-2,2′-(pyridylene-3″,5″)-bibenzimidazole; poly-2,2′-(furylene-2″,5″)-5,5′-bibenzimidazole; poly-2,2′-(naphthalene-1″,6″)-5,5′-bibenzimidazole; poly-2,2′-(biphenylene-4″,4″)-5,5′-bibenzimidazole; poly-2,2′-amylene-5,5′-bibenzimidazole; poly-2,2′-octamethylene-5,5′-bibenzimidazole; poly-2,6′-(m-phenylene) diimidazobenzene; poly-(1-(4,4′-diphenylether)-5-oxybenzimidazole)-benzimidazole; poly-(1-(2-pyridine)-5-oxybenzimidazole)-benzimidazole; Poly-(3-(4-(6-(1-benzimidazol-5-yloxy)-1-benzimidazol-2-yl)phenyl)-3 phenylisobenzofuran-1(3H)-one) and polybenzimidazole.

13. A membrane M according to claim 1, wherein the monomeric units U′ of the sulfonated polymer SP comprise at least one divalent moiety selected from the group consisting of:
(A) divalent C₁-C₁₀ alkanediyl; divalent C₂-C₁₀ alkenediyl;
(B) divalent C₆-C₁₅ aryl; and
(C) divalent C₃-C₁₀ cycloalkanediyl;
wherein any alkyl or alkenyl groups of the divalent moieties A, B and C, which have more than 2 carbon atoms, may comprise a heteroatom, selected from O and S, or a group —NR¹—, where R¹ is hydrogen or C₆-C₁₁ alkyl, within the alkyl or alkenyl chain of carbon atoms;
wherein any cycloalkyl, cycloalkenyl or aryl groups of the divalent moieties A, B and C may comprise 1, 2, 3 or 4 heteroatom(s) selected, independently from one another, from O, S and N, as ring member atoms;
wherein any of the aforementioned aliphatic, alicyclic, heterocyclic and aromatic groups of the definitions of the divalent moieties A, B and C may partially or completely be halogenated by fluorine and/or may carry 1, 2, 3 or 4 substituent(s) L, which may be the same or different, wherein
L is selected from the group consisting of hydroxyl; C₁-C₆ alkyl; C₂-C₆ alkenyl; C₆-C₁₂ aryl; C₅-C₁₂ heteroaryl; where L may partially or completely be halogenated by fluorine, and where L may be bonded via a divalent bridging group —O—, and where two vicinal substituents L together may be (═O) or (═S);
and wherein any two adjacent divalent moieties A, B and/or C, which belong either to the same monomeric unit U′ or to adjacent monomeric units U′ of the sulfonated polymer SP, may be covalently bonded to one another by a single carbon-carbon bond or by a divalent bridging group selected from the group consisting of —O—, —S—, —(C═O)—, —(C═O)O—, —O(C═O)—, and —S(═O)₂—.

14. A membrane M according to claim 13, wherein the monomeric units U′ of the sulfonated polymer SP carry at least one moiety —SO₃H and comprise 1, 2, 3, 4 or 5 divalent moiety(moieties), selected from the group consisting of:
(A) divalent C₁-C₁₀ alkanediyl; and
(B) divalent C₆-C₁₅ aryl;
wherein any of the divalent moieties A or B may be modified as defined in claim 13, with the proviso that 1, 2 or 3 of the divalent moieties A or B of the monomeric units U′ may comprise 1 or 2 substituent(s) L, which may be the same or different, wherein
L is selected from the group consisting of C₁-C₆ alkyl; C₆-C₇ aryl; C₅-C₆ heteroaryl; where L may partially or completely be halogenated by fluorine, and where L may be bonded via a divalent bridging group —O—;
and wherein any two adjacent divalent moieties A and/or B, which belong either to the same monomeric unit U′ or to adjacent monomeric units U′ of the sulfonated polymer SP, may be covalently bonded to one another by a single carbon-carbon bond or by a divalent bridging group selected from the group consisting of —O—, —S—, —(C═O)—, and —S(═O)₂—.

15. A membrane M according to claim 13, wherein the monomeric units U′ of the sulfonated polymer SP comprise from 2 to 30 divalent moieties (A),
wherein (A) is divalent C₁-C₁₀ alkanediyl;
wherein any of the divalent moieties A may be modified as defined in claim 13, with the proviso that 1, 2 or 3 of the divalent moieties A of the monomeric units U′ may comprise 1 or 2 substituent(s) L, which may be the same or different, wherein
L is selected from the group consisting of C₁-C₆ alkyl; C₆-C₇ aryl; C₅-C₆ heteroaryl; where L may partially or completely be halogenated by fluorine, and where L may be bonded via a divalent bridging group —O—;
and wherein any two adjacent divalent moieties A, which belong either to the same monomeric unit U′ or to adjacent monomeric units U′ of the sulfonated polymer SP, may be covalently bonded to one another by a single carbon-carbon bond or by a divalent bridging group selected from the group consisting of —O—, —S—, —(C═O)—, and —S(═O)₂—.

16. A membrane M according to claim 1, wherein the sulfonated polymer SP is selected from the group consisting of perfluorosulfonic acid, sulfonated polystyrene, sulfonated poly(ether ether ketone), sulfonated poly(arylene ether ketone), sulfonated poly(ether ketone), sulfonated poly(ether ketone ketone), sulfonated poly(4-phenoxybenzoyl-1,4-phenylene), sulfonated polysulfones, sulfonated poly(phenylquinoxalines), sulfonated poly(2,6-diphenyl-4-phenylene oxide), and sulfonated polyphenylenesulfide.

17. A membrane M according to claim 16, wherein the sulfonated polymer SP is selected from the group consisting of:
perfluorosulfonic acid of formula (III): 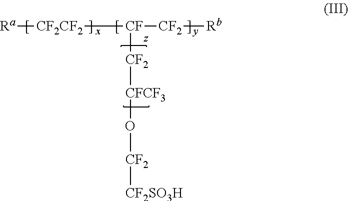
wherein x is an integer in the range of from 3 to 15; y is 1, 2 or 3; and z is 0, 1, 2 or 3; and where R^{a} and R^{b} may be the same or different and are selected from the group consisting of fluorine or trifluorinemethyl;
sulfonated polystyrene having monomeric units of formula (IV): 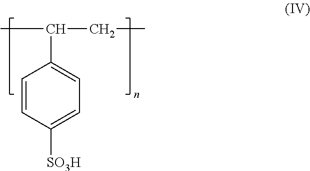
wherein n is an integer in the range of from 100 to 10,000;
sulfonated poly(ether ether ketone) having monomeric units of formula (V): 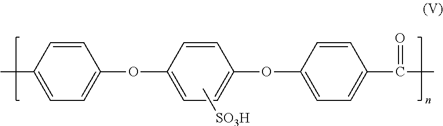
wherein n is an integer in the range of from 100 to 10,000;
sulfonated poly(arylene ether ketone) having monomeric units of formula (VI): 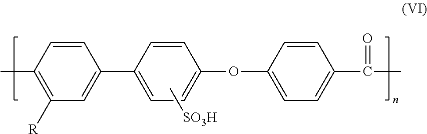
wherein n is an integer in the range of from 100 to 1,000; and R is selected from the group consisting of hydrogen, linear C₁-C₄ alkyl and C₇-C₁₀ arylalkyl;
sulfonated poly(ether ketone) having monomeric units of formula (VII): 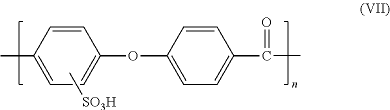
wherein n is an integer in the range of from 100 to 10,000;
sulfonated poly(ether ketone ketone) having monomeric units of formula (VIII): 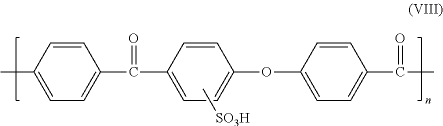
wherein n is an integer in the range of from 100 to 10,000;
sulfonated poly(4-phenoxybenzoyl-1,4-phenylene) having monomeric units of formula (IX): 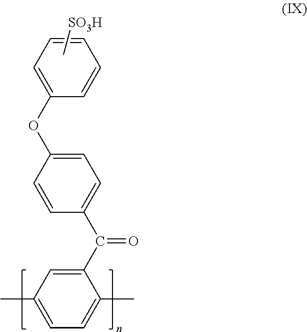
wherein n is an integer in the range of from 100 to 10,000;
sulfonated polysulfones having monomeric units of formula (X): 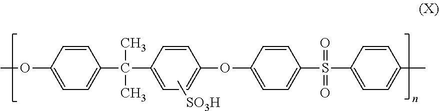
wherein n is an integer in the range of from 100 to 10,000;
sulfonated poly(phenylquinoxalines) having monomeric units of formula (XI): 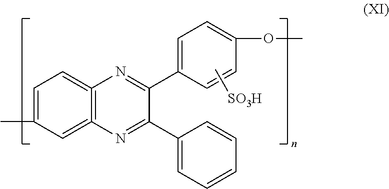
wherein n is an integer in the range of from 100 to 10,000;
sulfonated poly(2,6-diphenyl-4-phenylene oxide) having monomeric units of formula (XII): 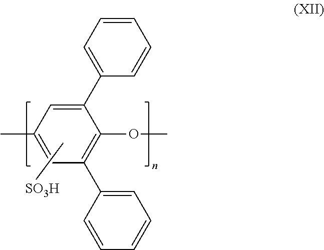
wherein n is an integer in the range of from 100 to 10,000; and
sulfonated polyphenylenesulfide having monomeric units of formula (XIII): 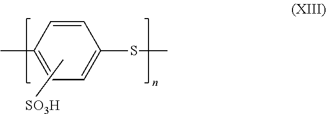
wherein n is an integer in the range of from 100 to 10,000.

18. A membrane M according to claim 1, wherein the polybenzimidazole polymer PBI and/or the sulfonated polymer SP, independently from one another, each have a number average molecular weight M_{N} in the range of from about 500 to about 1,000,000.

19. A membrane M according to claim 1, wherein the membrane M has a thickness in the range of from about 20 to about 200 μm under conditions where the membrane M is essentially free of water.

20. A membrane M according to claim 1, wherein the membrane M has a water content of 5 wt.-% or less, based on the total weight of the membrane M.

21. (canceled)

22. A proton exchange membrane fuel cell according to claim 27, wherein the membrane M further comprises a Boron-based electron-deficient compound BC; preferably in an amount of from 0.1 to 0.5 wt.-%, based on the total weight of the polymers PBI and SP together.

23. A proton exchange membrane fuel cell, in particular a polymer electrolyte membrane fuel cell or a direct methanol fuel cell, comprising a proton exchange membrane M, as defined in claim 1, which is designed to operate under conditions where the membrane M is essentially free of water at a temperature of 100° C. or more, and wherein at said temperature the membrane M exhibits a proton conductivity of at least 10⁻⁵ S/cm, as measured by impedance method.

24. A Method for the production of a proton exchange membrane M as defined in claim 1, comprising the following steps:
(i) providing a solution of a polybenzimidazole polymer PBI, as defined in claim 1, and a sulfonated polymer SP, as defined in claim 1, in an organic solvent OS, wherein the weight ratio of PBI:SP is in the range of from 1:99 to 20:80, whereby a reaction mixture RM is obtained;
(ii) applying the reaction mixture RM obtained in step (i) to a substrate S;
(iii) heating the substrate S obtained in step (ii) such that essentially all solvents are evaporated from the reaction mixture RM applied on the substrate S, whereby a membrane film MF is obtained; and subsequently heating the membrane film MF thus obtained to a temperature of at least 130° C.

25. A method according to claim 24, further comprising
(iv) treating the membrane film MF obtained in step (iii) with an oxidizing agent and subsequently with an inorganic acid whereby a membrane film MF′ is obtained; and
(v) treating the membrane film MF′ obtained in step (iv) with a purified solvent at an elevated temperature, and subsequently drying the membrane film MF′, preferably under high vacuum, whereby a membrane M is obtained.

26. A method according to claim 24, wherein the organic solvent OS used in step (i) is selected from the group consisting of N,N-dimethylacetamide, N,N-dimethylformamide, N-methylpyrrolidone, dimethyl sulphoxide, and a mixture thereof.

27. A proton exchange membrane fuel cell according to claim 23, wherein the membrane M comprises from 0.1 to 20 wt.-% of the polybenzimidazole polymer PBI; and wherein the membrane M comprises from 80 to 99.9 wt.-% of the sulfonated polymer SP, in each case based on the total weight of the polymers PBI and SP together.
